(19) United States
(12) Patent Application Publication
(10) Pub. No.: US 2022/0214465 A1
(43) Pub. Date: Jul. 7, 2022

(54) TOOL FOR RECOVERING A SEISMIC APPARATUS AT LEAST PARTIALLY INSERTED IN THE GROUND, RELATED ASSEMBLY AND METHOD

(71) Applicant: TOTALENERGIES SE, COURBEVOIE (FR)

(72) Inventors: Frank ADLER, IDRON (FR); Jean-Luc BOELLE, LESCAR (FR); Isabella MASONI, PAU CEDEX (FR); Jules BROWAEYS, IDRON (FR); Rémi ESTIVAL, PAU CEDEX (FR); Bruno PAGLICCIA, MORLAAS (FR); Ekaterina SHIPILOVA, PAU CEDEX (FR); Florent BERTINI, PAU CEDEX (FR); Pierre-Olivier LYS, PAU (FR)

(73) Assignee: TOTALENERGIES SE, COURBEVOIE (FR)

(21) Appl. No.: 17/609,604

(22) PCT Filed: May 7, 2019
(86) PCT No.: PCT/IB2019/000722

§ 371 Date: Nov. 8, 2021

(51) Int. Cl. G01V 1/16; B64C 39/02

(52) U.S. Cl. CPC G01V 1/16; B64C 2201/12; B64C 39/024

(57) ABSTRACT

The tool comprises-:
a support comprising at least a lower surface intended to rest on the ground;
a lifting system, carried by the support, the lifting system having at least a movable extraction member able to cooperate with the seismic apparatus and an actuator able to actuate the extraction member to lift the seismic apparatus out of the ground,
the distance separating vertically the lower surface from the lifting system being at most 2 m.

### CROSS REFERENCE TO RELATED APPLICATION

The present application is a U.S. National Phase Application under 35 U.S.C. §371 of International Patent Application No. PCT/162019/000722 filed May 7, 2019. The entire contents of which are hereby incorporated by reference.

### TECHNICAL FIELD

The present invention concerns a tool for recovering a seismic apparatus at least partially inserted in a ground.

The seismic apparatus is for example a probe able to collect seismic data generated in the ground by a seismic source. In a variant, the seismic apparatus is a seismic source.

The probe is in particular intended to form a receiver including at least a seismic sensor to conduct a geophysical survey in a region of interest.

The region of interest is preferentially an open area, in particular a desert or a steppe.

In a variant, the region of interest is a region with a difficult access. The region in particular comprises a high density of vegetation, such as a forest, such as a tropical forest. Also, the region may comprise rugged terrain such as hills (for example foothills), cliffs and/or mountains. Also, the region may comprise dangerous to access areas, such as areas with unexploded ordinances (UXO's).

### BACKGROUND

Geophysical measurements obtained during such a survey are critical in building a sub-surface earth image representative of the particular geology in the region of interest, in particular to determine the location of potential reservoirs of oil and gas.

Such a geophysical survey is for example conducted by placing an array of seismic sources in contact with or into the ground in the region of interest and by deploying seismic receivers able to record reflections of seismic signals produced by the successive sources on the different layers of the earth.

The survey generally requires implanting the sources at various locations, and introducing receivers partially in the ground along several lines to create a dense array of receivers.

The quality of the image obtained after the survey is generally a function of the surface density of sources and/or of receivers. In particular, a significant number of receivers have to be put in place in the ground to obtain an image of good quality. This is in particular the case when a three-dimensional image is required.

Placing and removing sources and sensors in a remote region of interest may be a tedious, dangerous and expensive process. In particular, when the region is barely accessible, such as in a tropical forest and/or in a region with uneven terrain, and/or in a region with UXOs, the sources and the sensors must be carried at least partially by foot by teams of operators. In many cases, clearings must be opened in the forest to place on the ground the relevant equipment and operators. Trails must then be cleared in the forest to put in place the receivers.

These tasks create a strong environmental impact in the region of interest and may induce significant health and safety risks for the operators.

The set-up of the receivers and/or the sources in the ground is a long process which often requires drilling the ground, and in the case of the receivers, ensuring that the coupling between the receiver and the ground is adequate.

Moreover, in order to limit environmental impact, the receivers must be removed after collecting the relevant data. This requires another long and costly operation to reach the receivers, and remove them from the ground. Such an operation has also an impact on the environment and creates additional risks for the operators.

In order to simplify the set-up of the probes, WO2016/139503 discloses a method in which the probes have the shape of a dart and are deployed by free fall from flying vehicles.

Nevertheless, such a solution is not entirely satisfactory. Indeed, it still requires an operation for removing each probe at the end of the survey. This operation is time and fuel consuming, involves health and safety risks for the operators and generates a strong environmental impact, for example due to logging of large areas of forest.

Moreover, when the probe is deployed with a drone using the free fall technique, the burial of the probe may be very significant, in particular in soft soil. As a consequence, the extraction strength which is required to remove the probe may in some cases exceed 500 Newtons. Intervention of a human team on site is therefore necessary.

One aim of the invention is to provide a simple and very easy to operate tool which facilitates the removal of seismic apparatus, in order to minimize environmental impact of a seismic survey.

### SUMMARY

To this aim, the subject-matter of the invention is a tool for recovering a seismic apparatus at least partially inserted in a ground, comprising:
a support comprising at least a lower surface intended to rest on the ground;
a lifting system, carried by the support, the lifting system having at least a movable extraction member able to cooperate with the seismic apparatus and an actuator able to actuate the extraction member to lift the seismic apparatus out of the ground, the distance separating vertically the lower surface from the lifting system being at most 2 m.

The tool according to the invention may comprise one or more of the following features, taken solely, or according to any potential technical combination:
the support comprises at least a leg defining at its lower end, the lower surface, and at least a supporting base intended to be located above and apart from the lower surface when the lower surface rests on the ground, the supporting base carrying the lifting system;
the tool preferentially comprising several legs, each defining a lower surface;
the actuator is able to generate a rotating and/or a translating and/or a vibrational movement of the extraction member and;
the actuator is electrically powered, the tool comprising at least a battery electrically connected to the actuator to power the actuator.

The invention also concerns a recovery system comprising:
a tool as defined above;
at least a vehicle, able to carry the tool from a remote location to a location above the seismic apparatus.

The system according to the invention may comprise one or more of the following features, taken solely or according to any potential technical combination:
the vehicle is an unmanned aerial vehicle, or an unmanned ground vehicle.

The invention also concerns an assembly comprising
a seismic apparatus;
a tool as defined above.

The assembly according to the invention may comprise one or more of the following features, taken solely, or according to any technical combination:
the seismic apparatus comprises a cooperation member, in particular a ring, a hook or a ball, able to cooperate with the extraction member of the lifting system;
the seismic apparatus comprises at least a first part, and at least a second part detachable from the first part, the lifting system being able to cooperate with the second part independently of the first part to lift the second part independently of the first part;
the seismic apparatus comprises a disengageable connection between the first part and the second part and,
the assembly comprises at least a signaling probe, able to be launched from the seismic apparatus after a communication failure and/or when a search signal sent from an external device is received.

The invention also concerns a method for recovering at least one seismic apparatus at least partially inserted in the ground, comprising the following steps:
providing a recovery tool as defined above;
placing the support of the recovery tool above the seismic apparatus with at least a lower surface resting on the ground, the distance separating vertically the lower surface from the lifting system being at most 2 m;
establishing a cooperation between the movable extraction member of the lifting system and the seismic apparatus;
actuating the extraction member with an actuator to lift the seismic apparatus out of the ground.

The method according to the invention may comprise one or more of the following features, taken solely, or according to any potential technical combination:
it comprises rotating, translating, and/or vibrating the seismic apparatus by actuating the extraction member;
providing the recovery tool comprises carrying the recovery tool with a vehicle to the location of the seismic apparatus, in particular with an unmanned ground vehicle and/or an unmanned aerial vehicle;
the seismic apparatus comprises at least a first part and at least a second part detachable from the first part, the method comprising lifting the second part independently of the first part with the lifting system.

The invention also relates to a seismic apparatus to be partially inserted in the ground, comprising:
a hollow casing;
at least a signaling probe, able to be launched from the hollow casing after a communication failure and/or when a search signal sent from an external device is received.

By “communication failure”, it is meant for example that the seismic apparatus is unable to communicate with an external unit, such as an external control apparatus or an external data recovery apparatus for a predetermined time. The predetermined time is for example one hour, one day or several days

The seismic apparatus preferentially comprises one or more of the following features, taken alone, or according to any technical feasible combination:
the signaling probe comprises at least an inflatable member able to be stored in a deflated configuration in the hollow casing and to occupy an inflated configuration when launched out of the hollow casing;
the signaling probe comprises a cable connecting the hollow casing with the inflatable device;
the signaling probe comprises at least an electronic communication device introduced into the inflatable device or connected to the inflatable device to allow communication with an external detection apparatus;
the seismic apparatus is a seismic source comprising an explosive or a mechanical device such as a hammer and/or a vibrator, the seismic source being able to generate a geophysical stimulus;
the seismic apparatus is a seismic probe, comprising a sensor unit comprising at least a sensor received in the hollow casing to sense a seismic signal;
the seismic probe further comprises an emitter able to collect and send data representative of the physical quantity sent by the sensor unit, and at least a power source able to power the sensor unit and/or the emitter, the emitter and the power source being received in the hollow casing.
the seismic apparatus comprises a signaling probe control unit able to trigger the launch of the signaling probe;
the signaling probe control unit is able to launch the inflatable device when detecting that the seismic apparatus has a communication failure and/or when a search signal sent from an external device is received by the signaling probe control unit.

The invention also relates to a method of recovering a seismic apparatus comprising the following steps:
provision of a seismic apparatus as defined above, on the ground or in the ground;
when the seismic apparatus has a communication failure and/or when a search signal sent from an external device is received by the signaling probe control unit, advantageously after a sandstorm, launch of the signaling probe from the hollow casing, and protrusion of the signaling probe out of the ground.

The method according to the invention may comprise one or more of the following features:
automatic detection of a communication failure by a signaling probe control unit and launch of the signaling probe upon the automatic detection;
it comprises the following steps:
emission, by an external device, of a recovery signal;
detection of the recovery signal by a signaling probe control unit;
launch of the signaling probe after detection of the recovery signal.
the launch of the signaling probe comprises inflating an inflatable member of the recovery probe;
the method comprises, after launching the signaling probe, emitting a signal with an emitter received in the probe, or carried by the probe.

### BRIEF DESCRIPTION OF THE DRAWINGS

The invention will be better understood, based on the following description, given solely as an example, and made in reference to the following drawings, in which:

FIG. 1 is a schematic view of a ground survey assembly in which a recovery tool according to the invention can be used;

FIG. 2 is a view illustrating the setting in place of a seismic apparatus into the ground in a region of interest;

FIG. 3 is detail of the seismic apparatus inserted in the ground after the step shown in FIG. 2;

FIG. 4 is a view similar to FIG. 2, during the recovery of the seismic apparatus by a recovery tool according to the invention;

FIG. 5 is a view analogous to FIG. 3, in which the recovery tool has been placed above the seismic apparatus to recover;

FIG. 6 is a view of the ground, after recovery of at least part of the seismic apparatus;

FIGS. 7 and 8 are views respectively similar to FIG. 5 and FIG. 6 of a second seismic apparatus recovered by the recovery tool according to the invention;

FIG. 9 and FIG. 10 are views respectively similar to FIG. 5 and FIG. 6 of a third seismic apparatus recovered by the recovery tool according to the invention;

FIG. 11 and FIG. 12 are views respectively of a seismic apparatus equipped with a signaling probe, the signaling probe being respectively in a rest configuration and in a launched configuration;

FIG. 13 is a view of another recovery system according to the invention operating in an open field.

### DETAILED DESCRIPTION

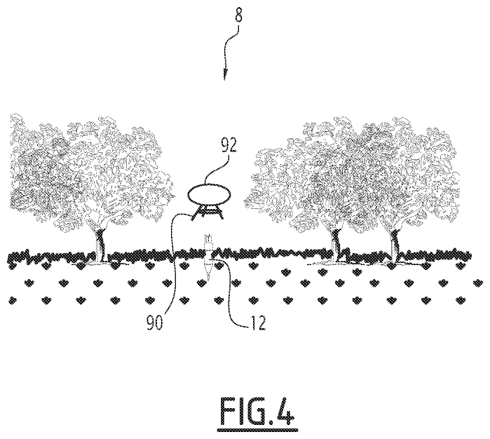

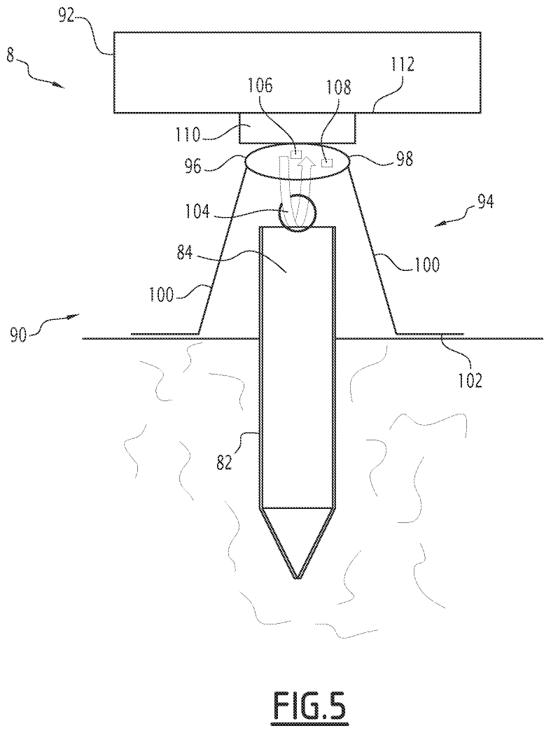

A first recovery system 8 according to the invention is shown schematically in FIGS. 4 and 5. The recovery system 8 is intended for recovering at least a seismic apparatus, for example a probe 12 of a ground survey assembly 10 at least partially inserted in the ground.

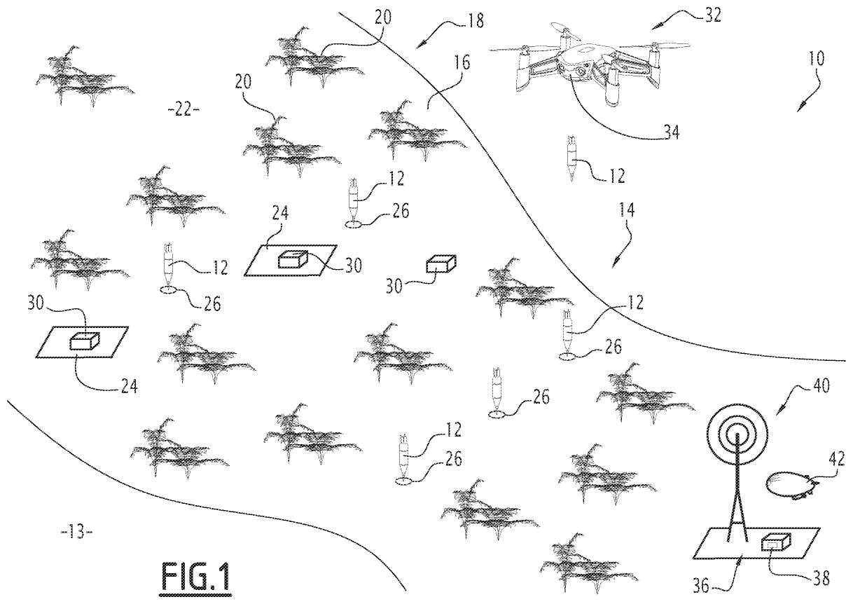

An example of a ground survey assembly 10 comprising at least a probe 12 is disclosed schematically in FIG. 1.

The ground survey assembly 10 is for carrying out a geophysical survey of an onshore region of interest 14, schematically shown in FIG. 1.

The assembly 10 is used in particular to collect geophysical data and measurements for determining the physical properties of the subsurface 13 located in the region of interest and/or for building an image of the geology of the subsurface 13, preferably a tridimensional image of the subsurface 13.

The subsurface 13 located below the ground comprises layers of geological formation and potentially oil and gas reservoirs.

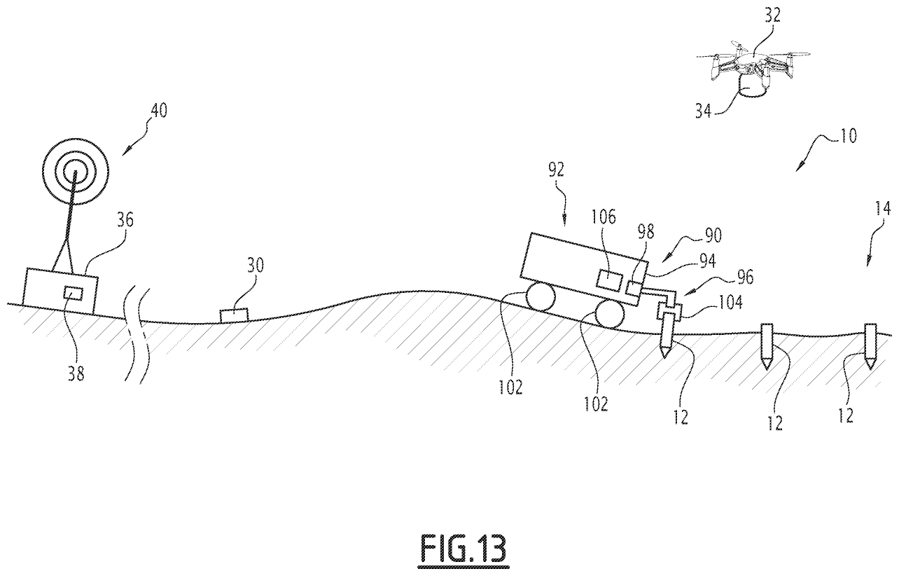

In a preferred embodiment, shown for example in FIG. 13, the region of interest 14 is an open land such as a desert or a steppe.

In a variant, shown in FIG. 1, the region of interest 14 is for example a region having an uneven terrain 16. The uneven terrain 16 in particular comprises hills, mountains, cliffs or any type of rugged terrain. The region of interest 14 is for example located on foothills which are difficult to access.

In the example shown in FIG. 1, the region of interest 14 further comprises vegetation 18. The vegetation 18 is for example a forest, in particular a tropical forest. It typically comprises a high density of vegetation, for example trees 20 forming a canopy 22 which covers a majority of the surface of the ground in the region of interest 14.

In the region of interest 14, the vegetation 18 defines a plurality of natural and/or artificial clearings 24 offering an access to the ground through openings in the canopy 22. The vegetation 18 in the region of interest 14 also defines sky holes 26 in the canopy 22.

The clearings 24 are spread in the region of interest 14, at a distance generally comprised between 100 m and 500 m, preferentially around 300 m, taken along the line of sight between two adjacent clearings 24.

The clearings 24 generally have a surface area greater than 25 m², at the ground level and generally greater than 900 m² at the top of the canopy 22. The seismic sources 30 can be put in place in the clearings 24.

A clearing 24 is for example defined in a OGP Standard “OGP-Helicopter Guideline for Land Seismic and Helirig operations—Report 420 version 1.1 June 2013

Sky holes 26 are generally natural. They advantageously form a vertical “light tube” between the canopy 22 and the ground.

For example, the sky holes 26 have a minimal surface area greater than 1 m² , preferentially greater than 3 m², and comprised for example between 3 m² and 20 m².

The probes 12 are able to be dropped in each sky hole 26, or in a clearing 24 as will be described later.

At least a sky hole 26 has a surface area which is smaller than the surface area of the clearings 24.

In the examples of FIG. 1 and FIG. 13, the ground survey assembly 10 comprises a plurality of sources 30, able to generate a geophysical stimulus in the ground, in particular a seismic signal. The ground survey assembly 10 further comprises a plurality of probes 12 spread in the region of interest 14 to collect geophysical data arising from the seismic signal generated by the sources 30.

In the examples of FIG. 1 or 13, the ground survey assembly 10 further comprises a fleet of flying vehicles 32, able to fly above the ground to carry each probe 12 above its point of installation, and, for each flying vehicle 32, a launching unit 34 able to separate each probe 12 carried by the flying vehicle 32 to let the probe 12 free fall to its installation point in the ground.

In a variant, the probe 12 can be launched toward the ground. The launching impulse can be obtained by the integration of a thruster (ex: pyrotechnic, turbine, propeller . . . ) in the probe 12, or by the use of a propulsion mechanism onboard the probe carrier flying vehicle 32 (e.g. launching actuator or the decompression of a spring).

In yet another variant, the fall of the probe 12 can be slowed down by a braking mechanism (e.g. a parachute attached to the rear closing part). Slowing down the fall of the probe 12 can for instance avoid damages to the probe 12.

In another variant (not shown), the probes 12 are deployed from a terrestrial vehicle, such as an unmanned ground vehicle.

The ground survey assembly 10 further comprises at least a base 36 (or secondary camp), comprising at least a collection and/or analysis unit 38 and a telecommunication system 40 able to transfer data measured by the probes 12 to the collection and/or analysis unit 38, and from the collection and/or analysis unit 38 to an external station (not shown).

The base 36 advantageously comprises a helipad, night facilities for crews, and/or antenna which collect data from small antenna located in the vicinity. It is used for management of the take-off and landing. It may be used for first aid (e.g. medevac).

The external station may be located at a main camp (not shown). The main camp advantageously comprises facilities for collecting data, as well as a main computing unit, and/or a control center.

Advantageously, the ground survey assembly 10 comprises at least an additional flying vehicle 42 such as a helicopter, an airship, able to fly over the ground to carry the sources 30.

Each seismic source 30 is able to generate a controlled seismic energy generating a geophysical stimulus, in particular a seismic signal in the ground.

The source 30 for example may comprise an explosive, in particular dynamite, able to generate the geophysical stimulus.

The source 30 is inserted in a hole drilled into the ground, for example at a depth comprised between 0 meter and 100 meters, preferably between 5 meters and 80 meters.

In a variant, the source 30 comprises a mechanical device such as a hammer, a vibrator.

In an open region of interest such as a desert or steppe shown in FIG. 13, the density of sources 30 is generally greater than 100 source locations per km² with at most a few dozen of meters between sources.

Each probe 12 is partially introduced in the ground to sense in particular the seismic signals resulting from interactions of the seismic stimulus generated by a source 30 with the geology of the subsurface 13.

The density of probes 12 is comprised for example between 10 probes per km² and 1000 probes per km², in particular between 300 probes per km² and 500 probes per km², notably 400 probes per km².

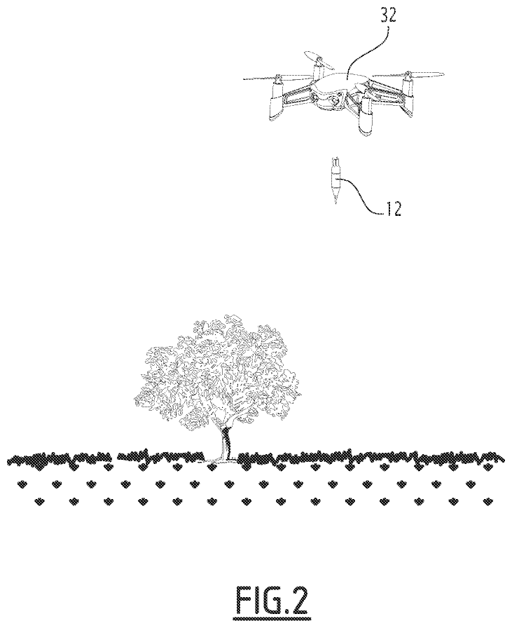

In the example shown in FIG. 2, each probe 12 has the shape of a dart. In a variant, the probe 12 has the shape of a ball or of a parallel pipe.

The probe 12 advantageously comprises a hollow casing defining a closed inner compartment, a sensor unit comprising at least a sensor received in the closed inner compartment to sense at least a physical quantity, in particular a seismic signal.

The probe 12 further comprises an emitter able to collect and send data representative of the physical quantity sensed by the sensor unit, and at least a power source able to power the sensor unit and/or the emitter. The emitter and the power source are also received in the closed inner compartment of the hollow casing.

The sensor unit comprises at least a geophysical sensor such as a geophone or a microelectromechanical system (MEMS) sensor.

In a variant, the sensor unit comprises at least an accelerometer, and/or a thermometer.

The sensor unit advantageously comprises at least one geophone, in particular three geophones and/or accelerometers.

Each sensor of the sensor unit is able to sense a physical quantity, in particular a ground movement (velocity and/or acceleration) and to convert it into a signal which may be recorded and/or sent away.

The emitter comprises a data recovery unit able to digitalize, process and store the data measured by each sensor. The emitter for example comprises a processor and a memory.

The emitter is able to communicate with another emitter of another probe 12 located in the vicinity of the probe 12 and/or with an antenna of the telecommunication system 40. It is able to transfer data representative of the physical quantity measured by each sensor along time to another probe 12 and/or to an antenna of the telecommunication system 40.

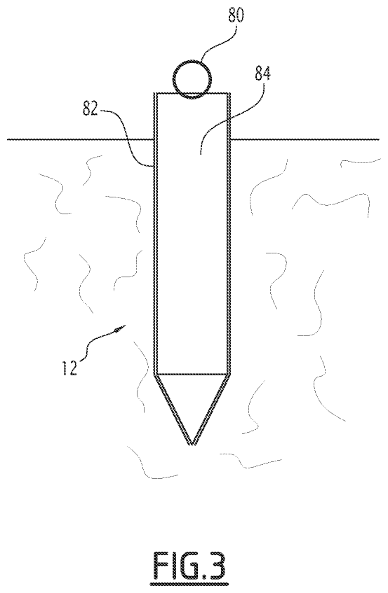

In the example of FIG. 3, the probe 12 further comprises a cooperating member 80 intended to cooperate with the recovery tool 8.

The cooperation member 80 is preferentially located at the top end of the probe 12 when the probe 12 is vertically inserted in the ground. It preferentially protrudes above the top end.

In the example of FIG. 3, the cooperating member 80 is a ring. In a variant, the cooperating member 80 is a hook or a hook like member.

In yet another variant, the cooperating member 80 is a protrusion able to engage into a female part of the movable extraction member 104.

In yet another variant, the cooperating member 80 is a hole able to cooperate with a harpoon like device of the movable extraction member 104.

In another variant, the probe 12 does not comprise a cooperation member 80.

In the example shown in FIG. 3, the probe 12 comprises a first external part 82 intended to remain in contact with the ground, and an internal part 84 formed of the hollow casing containing the sensor unit, the power source, and the emitter.

The first external part 82 comprises a tubular sleeve applied around the internal part 84. The sleeve has an inner shape complementary to the outer shape of the second part 84. It extends from the lower end to the upper end of the external part 84.

The sleeve is potentially covered with a gel which decreases its adherence in soil and/or with the second part 84. The sleeve is preferentially made of a biodegradable material and/or of a chemically degradable material.

By “biodegradable”, it is meant a material which is able to be mineralized by soil microorganisms and or by air microorganisms. For example, a biodegradable material is a material in which more than 90% of the material is converted into carbon dioxide and water by the actions of microorganisms within two years, preferably within one year, more preferably within six months.

Biodegradability can be measured for example according to standard ASTM D5988-12 whose title is “Standard test methods for determining aerobic biodegradation of plastic materials in soil”.

By “chemically degradable”, it is meant a material which is able to be mineralized by chemical reactions with components of the soil and/or with light, in particular with UV light. For example, a chemically degradable material is a material in which more than 90% of the material loses its structure within two years, preferably within one year, more preferably within six months.

Advantageously, the biodegradable material and/or chemically degradable material is degraded in less than within 2 years, preferably within one year, more preferably within 6 months after the contact of the probe 12 with the ground.

When the probe 12 is inserted in the ground, the sleeve forming the first external part 82 is directly in contact with the ground, whereas the second external part 84 is shielded from the ground by the sleeve.

When used, the flying vehicle 32 is for example an unmanned aerial vehicle (UAV) piloted from the base 36 to reach a launching point in particular above a sky hole 26.

The launching unit 34 comprises a mechanical retainer able to be operated from a probe retaining configuration in which the retainer holds the probe 12 and a dropping configuration, in which the retainer frees the probe 12 to let it fall down from the flying vehicle 32.

The telecommunication system 40 comprises antennas located in at least part of the clearings 24, and/or flying antennas. It is able to collect data received from the emitter of each probe 12 and to convey it to the collection and analysis unit 38 at the base 34.

As shown in FIGS. 4, 5 and 13, the recovery assembly 8 comprises at least a recovery tool 90 and a vehicle 92 able to carry the recovery tool 90 from a remote location to a location above the seismic apparatus, here a probe 12. The recovery tool 90 would work similarly with a source 30.

Preferentially, the recovery tool 90 is connected to the vehicle 92, for example by being fixed on the vehicle 92.

The recovery tool 90 comprises a support 94 and a lifting system 96, carried by the support 94.

In the example of FIGS. 4 and 5, the support 94 comprises a supporting base 98, intended to be located above and apart from the ground and several legs 100 connected to the supporting base 98 to maintain the supporting base 98 above the ground when the legs are in contact with the ground.

Each leg 100 comprises an upper end connected to the supporting base 98 and a lower end defining a lower surface 102 intended to rest on the ground. In the example of FIG. 5, the lower surface 102 is defined by a horizontal foot located at the lower end of the leg 100.

The supporting base 98 carries the lifting system 96 at a height above the ground. The distance separating vertically the lower surface 102 from the supporting base 98 holding the lifting system 96 is at most 2 m, and is generally comprised between 0.3 m and 1 m.

The lifting system 96 comprises at least a movable extraction member 104 for cooperating with the cooperating member 80 of the seismic apparatus, an actuator 106 for actuating the extraction member 104 to lift the extraction member 104 along with the cooperation member 80 out of the ground and a power source 108 able to power the actuator 106.

In the example of FIG. 5, the extraction member 104 is a hook able to cooperate with the cooperating member 80, in particular able to engage into the ring or hook of the cooperating member 80.

The actuator 106 is for example a jack or a winch able to lift the extraction member 104 from a lower position, located closer to the ground between the legs 100 and an upper position, located remotely from the ground, closer to the supporting base 98.

In this example, the actuator 106 is electrically powered. It is able to generate a rotating and/or a translating and/or a vibrational movement of the extraction member 104.

The power source 108 is for example a battery, carried by the supporting base 98.

Advantageously, the lifting system 96 further comprises a control unit 110 able to control the actuation of the actuator 106 and the lifting of the extraction member 104 along with the cooperating member 80.

Advantageously, the control unit 110 further comprises at least a sensor able to precisely locate the supporting base 98 and the extraction member 104 to be able to cooperate with the cooperating member 80.

The vehicle 92 is preferentially an autonomous vehicle able to autonomously position the recovery tool 90 above the seismic apparatus, in particular to receive the seismic apparatus in the space between the legs 100 of the recovery tool 90.

In the example of FIGS. 4 and 5, the vehicle 92 is an autonomous flying vehicle, for example the flying vehicle 32 described above, equipped with a specific holder 112 able to carry the recovery tool 90.

Just as described above, the flying vehicle 32 is piloted from the base 36 to reach a recovery point above a probe 12. The holder 112 is able to releasably hold the recovery tool 90. In an embodiment, the holder 112 is able to position the recovery tool 90 at the location of a seismic apparatus, to detach from the recovery tool 90 and then to recover the recovery tool 90 later, once the seismic apparatus has been at least partially extracted from the ground.

In a variant shown in FIG. 13, the vehicle 92 is a terrestrial vehicle such as an unmanned ground vehicle. The supporting base 98 is carried by the structure of the vehicle which form a support 94 having a contact surface 102 with the ground. The contact surface 102 is either located on wheels or tracks of the vehicle 92 or on specific jacks having legs applied on the ground.

In a preferred embodiment, shown in FIG. 13, the lifting system 96 comprises an articulated arm able to catch the probe 12.

The installation and operation of the ground survey assembly 10 shown in FIG. 1 will be now described.

Initially, the location of a plurality of sources 30 and the location of a plurality of probes 12 in the region of interest 14 are defined.

The sources 30 and the probes 12 are carried to the base 36. The sources 30 are then put in place in the region of interest 14.

Each source 30 is installed in a hole drilled in the ground, before, during or after the deployment of the probes 12.

Then, each flying vehicle 32 is loaded with at least one probe 12 in the launching unit 34, preferably with several probes 12. Then, the flying vehicle 32 is flown over the region of interest 14 and the launching unit 34 is triggered to let each probe 12 fall down, as shown in FIG. 2. The probe 12, in particular its tapered end when available, penetrates the ground to couple the probe 12 with the ground.

The insertion of the probes 12 in the ground is made preferentially without the need of a man intervention on the ground. It is extremely simple and accurate, and it allows dropping a large number of probes 12, for example more than 1,000 probes a day.

In operation, at least one source 30 is triggered to generate a seismic stimulus. The seismic stimulus propagates in the ground and reflects against the different layers in the subsurface 13.

A seismic signal is captured by the sensors of the sensor unit. The signal is digitalized, conditioned and/or processed by the data recovery unit, and is stored. The collected data is then transmitted to the base 36 through the emitter and the telecommunication system 40.

The data is then transmitted to the collection and analysis unit 38 by the antennas of the telecommunication system 40.

Based on the data collected by each sensor of each probe 12, an image of the subsurface 13 in the region of interest 14, in particular a tridimensional image can be built with great accuracy.

Once the survey has been completed, the sources 30 are recovered advantageously using the same method as the one used to recover the probes 12 using the recovery system 8.

The probes 12 are also recovered. To this aim, the vehicle 92 is loaded with the recovery tool 90. The support 94 equipped with the lifting system 96 is attached to the vehicle 92.

The vehicle 92 then moves, preferentially autonomously, to the location of a probe 12.

In the example of FIG. 4, the vehicle 92 flies to the location of a probe 12. In the variant shown in FIG. 13, the vehicle 92 drives to the location of the probe 12.

The vehicle 92 senses where the probe 12 is located, and places the recovery tool 90 above the cooperating member 80 of the probe 12.

In the example of FIG. 4, the legs 100 of the support 94 are then positioned around the probe 12, with their lower surfaces 102 resting on the ground.

The cooperating member 80 of the probe 12 is located between the legs 100, below the extraction member 104, as shown in FIG. 5.

In the example of FIG. 13, the extraction member 104 is placed above the probe 12.

The actuator 106 is then powered by the power source 108 to place the extraction member 104 in a deployed position in cooperation with the cooperating member 80. The actuator 106 is then activated to generate a translation, a rotation and/or a vibration of the extraction member 104, and consequently of the probe 12, in order to detach at least part of the probe 12 from the ground.

The lifting system 96 lifts at least part of the probe 12 apart from the ground and above it, by counter reaction with the lower surfaces 102 resting on the ground.

The force developed by the lifting system 96 is therefore enough to disengage at least part of the probe 12 from the ground to recover it.

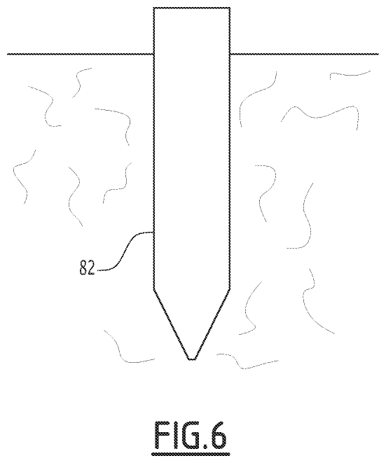

In the example of FIGS. 3 and 6, the second internal part 84 of the probe 12, which contains the sensor unit, the power source, and the emitter, is removed out of the ground, whereas the first external part 82, which is biodegradable and/or chemically degradable, remains in the ground.

Once at least the second part 84 of the probe 12 has been lifted out of the ground by the lifting system 96, the vehicle 92 moves back to the base 36 for the collection of the second part 84 of the probe 12 for example by the base staff.

In the example of FIG. 6, only the first biodegradable and/or chemically degradable external part 82 remains in the ground and is rapidly degraded by the environment.

Thanks to the invention, the recovery of a large number of probes 12 is easy to operate, without needing ground operators. The cost, time frame, and safety of the operation is therefore greatly enhanced.

The recovery tool 90 according to the invention is able to develop an extraction strength which is sufficient to efficiently remove the probe 12 from the ground, in a short time, in the order of less than 20 minutes, preferentially less than 10 minutes.

The vehicle 92 is then able to autonomously carry the recovery tool 90 and the extracted seismic apparatus towards a base 36.

The recovery tool 90 is adapted for different types of soils, and is operable wherever the vegetation lets an access.

The recovery tool 90 is also able to work in case the probe 12 is not vertically planted, and in case the surface surrounding the probe is not flat.

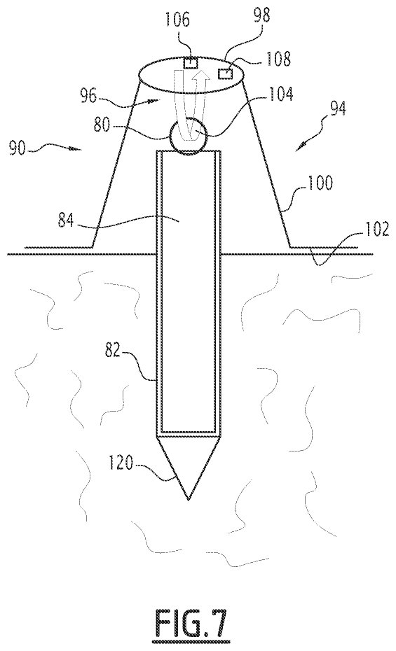

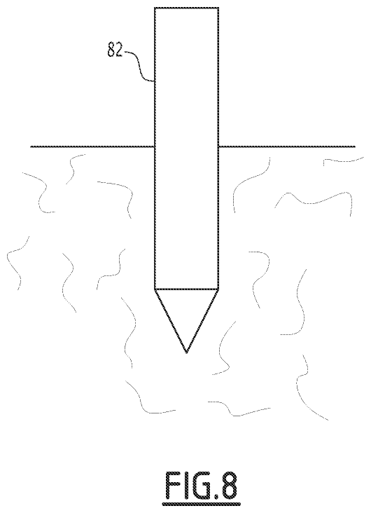

In the variant of FIGS. 7 and 8, a lower part 120 of the seismic apparatus having a tapered end is also made of a biodegradable material, which remains in the ground. The second internal part 84 is located above the lower tapered part 120, the cylindrical upper part 84 only being lifted out of the ground.

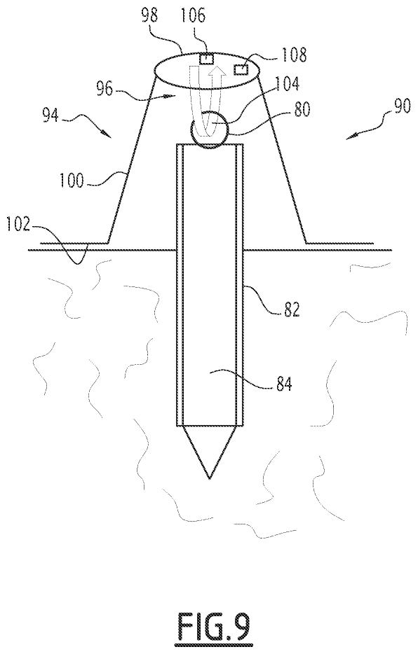

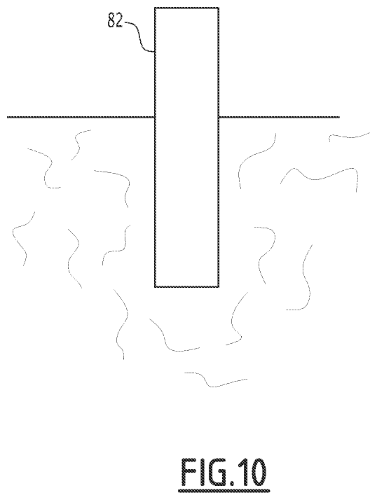

In the variant of FIG. 9, the sleeve forming the first external part 82 does not cover the lower tapered end of the second part 84. The lowered tapered end of the second part 84 is directly in contact with the ground. The first external part 82 is made of a cylindrical open sleeve, which is placed around the cylindrical upper region of the second internal part 84.

In other variants, the extraction member of the recovery tool 90 is a screw and is able to thread into the seismic apparatus before lifting the seismic apparatus, or is a coring tool, having a cylindrical cutting tool, able to cut around the seismic apparatus and to lift the seismic apparatus.

In another variant, the seismic apparatus comprises a disengageable connection between the first external part 82 and the second internal part 84. The disengageable connection is activated when the seismic apparatus is dropped from the flying vehicle 32. It is deactivated when the recovery tool 90 operates.

In a first embodiment, the disengageable connection is able to deactivate when the seismic apparatus impacts the ground. In another embodiment, the disengagement of the connection is activated by the recovery tool 90.

In again another embodiment, the disengageable connection is chemically or biologically degradable. The connection is for example an adhesive which degrades along time.

In another variation, the disengageable connection comprises a mechanism having sheaves, or a sheaves system able to demultiply the force applied by the recovery tool to provide a strong extraction force.

In again another variation, the vehicle 90 is able to store the extracted seismic apparatus so that the recovery tool 90 is able to extract another seismic apparatus, without having to move back to the base 36.

The vehicle 92 advantageously comprises a carrousel able to store several seismic apparatus in parallel.

In a variant, the probe 12 does not have a dart shape. It has for example the shape of a parallel pipe or of a ball.

In a variant (not shown), the probe 12 does not comprise an external part 82 intended to remain in contact with the ground. The probe 12 is fully recovered as a whole by the recovery tool 90.

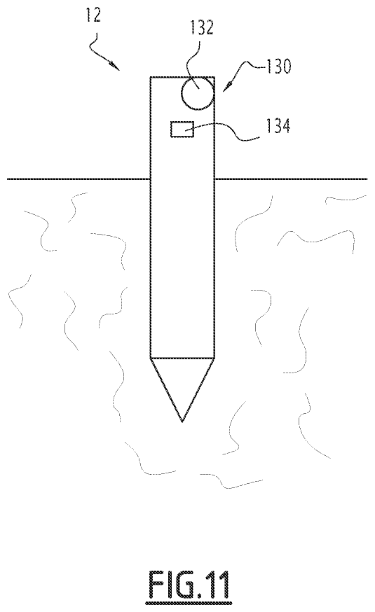

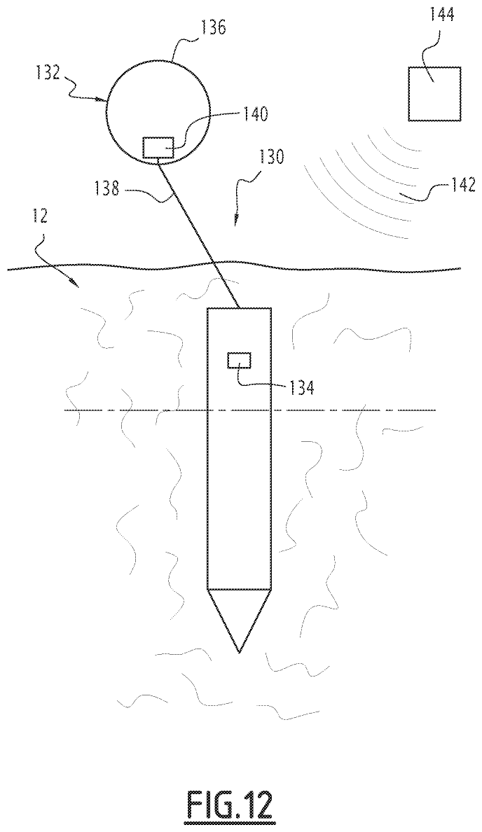

In a variant shown in FIGS. 11 and 12, the seismic apparatus comprises a signaling device 130 to deploy a signaling probe 132 from the hollow casing of the seismic apparatus when the seismic apparatus has a communication failure and/or when a search signal sent from an external device is received by the signaling probe control unit, advantageously after a sandstorm,

This may occur when a sandstorm lays material on the seismic apparatus, as shown in FIG. 12 or prior to the sandstorm, when a sandstorm is forecasted.

The signaling device 130 comprises the signaling probe 132 and a signaling probe control unit 134 able to control the signaling probe 132 from a rest configuration, in which it is totally confined in the hollow casing (as shown in FIG. 11) and a deployed position, shown in FIG. 12 in which the signaling probe 132 is deployed out of the hollow casing and preferably out of the ground when the hollow casing is buried underground.

The signaling probe 132 for example comprises an inflatable balloon 136. The balloon 136 is deflated in the rest configuration of the signaling probe 132. The balloon 136 is able to inflate when the signaling probe control unit 134 launches the signaling probe 132.

The signaling probe 132 further comprises a cable 138 able to connect the hollow casing to the inflatable balloon 136.

The signaling probe 132 advantageously comprises an emitter 140, connected to the inflatable balloon 136 or received in the inflatable balloon 136 to emit a detection signal when the signaling probe 132 occupies its deployed configuration, outside of the ground.

The signaling probe control unit 134 advantageously comprises an automated detection device, able to detect the burial of the seismic apparatus.

In addition or in variant, the signaling probe control unit 134 is able to detect a recovery signal 142 emitted by an external recovery apparatus 144, and to trigger the launch of the signaling probe 132 when the recovery signal is detected.

The operation of the seismic apparatus shown in FIGS. 11 and 12 will now be described.

Initially, the seismic apparatus is at least partially inserted in the ground. The signaling probe 132 of the signaling device 130 occupies its rest configuration confined into the hollow casing.

When the seismic apparatus has a communication failure, for example during a sandstorm, the signaling probe control unit 134 detects the communication failure of the seismic apparatus.

Upon detection, the signaling probe control unit 134 triggers the launch of the signaling probe 132. The inflatable balloon 136 is ejected out of the hollow casing and is sent above the surface of the ground by its inflation.

The inflatable balloon 136 is preferably inflated with a gas lighter than air. It therefore floats above the surface of the ground. It is connected to the hollow casing with a cable 138. The emitter 140, when available, emits a signal able to allow detection signaling probe 132.

Based on the position of the signaling probe 132, a crew recovers the seismic apparatus, for example using the tool 90 according to the invention.

In a variant, the triggering of the signaling probe control unit 134 is launched by reception of a signal 142 emitted from an external recovery device 144.

1. A tool for recovering a seismic apparatus at least partially inserted in a ground, wherein the tool comprises
a support comprising at least a lower surface intended to rest on the ground;
a lifting system, carried by the support, the lifting system having at least a movable extraction member able to cooperate with the seismic apparatus and an actuator able to actuate the extraction member to lift the seismic apparatus out of the ground,
the distance separating vertically the lower surface from the lifting system being at most 2 m.

2. The tool according to claim 1, wherein the support comprises at least a leg defining at its lower end, the lower surface, and at least a supporting base intended to be located above and apart from the lower surface when the lower surface rests on the ground, the supporting base carrying the lifting system.

3. The tool according to claim 1, wherein the actuator is able to generate a rotating and/or a translating and/or a vibrational movement of the extraction member.

4. The tool according to claim 1, wherein the actuator is electrically powered, the tool comprising at least a battery electrically connected to the actuator to power the actuator.

5. A recovery system, comprising:
a tool according to claim 1;
at least a vehicle, able to carry the tool from a remote location to a location above the seismic apparatus.

6. The recovery system according to claim 5, wherein the vehicle is an unmanned aerial vehicle, or an unmanned ground vehicle.

7. An Assembly, comprising:
a seismic apparatus ;
a recovery tool according to claim 1.

8. The assembly according to claim 7, wherein the seismic apparatus comprises a cooperation member able to cooperate with the extraction member of the lifting system.

9. The assembly according to claim 7, wherein the seismic apparatus comprises at least a first part, and at least a second part detachable from the first part, the lifting system being able to cooperate with the second part independently of the first part to lift the second part independently of the first part.

10. The assembly according to claim 9, wherein the seismic apparatus comprises a disengageable connection between the first part and the second part.

11. The assembly according to claim 7, comprising at least a signaling probe, able to be launched from the seismic apparatus after a communication failure and/or when a search signal sent from an external device is received.

12. A method for recovering at least one seismic apparatus at least partially inserted in the ground, comprising the following steps:
providing a recovery tool according to claim 1;
placing the support of the recovery tool above the seismic apparatus with at least a lower surface resting on the ground, the distance separating vertically the lower surface from the lifting system being at most 2 m;
establishing a cooperation between the movable extraction member of the lifting system and the seismic apparatus;
actuating the extraction member with an actuator to lift the seismic apparatus out of the ground.

13. The method according to claim 12, comprising rotating, translating, and/or vibrating the seismic apparatus by actuating the extraction member.

14. The method according to claim 12, wherein providing the recovery tool comprises carrying the recovery tool with a vehicle to the location of the seismic apparatus.

15. The method according to claim 12, wherein the seismic apparatus comprises at least a first part and at least a second part detachable from the first part, the method comprising lifting the second part independently of the first part with the lifting system.

16. The tool according to claim 2, wherein the tool comprises several legs, each defining a lower surface.

17. An assembly according to claim 8, wherein the cooperation member is a ring, a hook or a ball.

18. A method according to claim 14, wherein the vehicle is an unmanned ground vehicle and/or an unmanned aerial vehicle.
